(19) United States
(12) Patent Application Publication
(10) Pub. No.: US 2016/0363263 A1
(43) Pub. Date: Dec. 15, 2016

(54) SYSTEM AND METHOD FOR MOVABLY MOUNTING ARENA-TYPE DISPLAYS

(71) Applicants: Robert Stockham, Las Vegas, NV (US); James Gietzen, Las Vegas, NV (US)

(72) Inventors: Robert Stockham, Las Vegas, NV (US); James Gietzen, Las Vegas, NV (US)

(21) Appl. No.: 15/042,081

(22) Filed: Feb. 11, 2016

Related U.S. Application Data
(60) Provisional application No. 62/114,697, filed on Feb. 11, 2015.

(51) Int. Cl. F16M 13/02; G09F 7/20; F16M 11/08; F16M 11/18; F16M 11/42

(52) U.S. Cl. CPC F16M 13/027; F16M 11/18; F16M 11/425; F16M 11/08; G09F 7/20; G09F 2007/186

(57) ABSTRACT

A system for movably supporting one or more electronic displays, such as in an arena, includes a support structure which movably supports the electronic displays and driving elements configured to change the position of the displays. The position of the displays may be changed by changing the location and/or orientation of the displays. In one embodiment, the displays are suspended and may be moved along one or more tracks or rails or via one or more cables.

### CROSS REFERENCE TO RELATED APPLICATION

This application claims priority to U.S. Provisional Application No. 62/114,697 which was filed on Feb. 11, 2015, the contents of which are hereby incorporated by reference.

### BACKGROUND

The disclosed embodiments relate to electronic displays. More specifically, the disclosed embodiments relate to arena-type displays.

Event centers such as arenas, stadiums, concert halls, and other such venues often utilize electronic video displays (such as LED, LCD, or other types of electronic displays) to enhance a visitor's overall experience. In large event centers, such displays may help visitors more clearly see a speaker, performance, or sporting event by providing a large video display of the event to all who are in attendance. The displays may also provide relevant information during an event such as related videos or other media, replays, statistical information, advertising, and the like.

In an arena or similar setting, such displays may be suspended from a truss work in the ceiling of the arena. The displays are typically fixed to a common center steel frame to form a unified structure. For example, four displays may be fixed to the steel frame facing outwardly. Each display may be fixed so as to be oriented approximately ninety degrees from adjacent displays so that at least one display is visible to viewers at any position around the displays.

In arenas or other similar event centers and venues, it is important for the venue to be as versatile as possible to facilitate all kinds of events. For example, to maximize the use and revenue from an arena, the arena should be adaptable to allow for different sporting events such as basketball, tennis, wrestling, hockey, arena football, boxing, and the like. Further, it may also be desirable that the arena host non-sporting events such as concerts, political rallies or other speeches, conventions, or other special events.

Typical arena-type displays, however, often do not aid in such versatility. For example, an arena may host a concert where a stage is on one side of the arena. In this setup, a typical display system as described above may not provide a suitable viewing angle for all of the concertgoers in attendance. Further, different sporting events may be better served with different display setups. In an attempt to address these shortcomings, an arena operator may mount displays in other locations about the arena, such as on the walls or in other locations. However, the requirement for an increased number of displays increases the costs to the operator. Also, the location at which displays may be mounted may be constrained, such as by seats or other structures, thus limiting the ability of the operator to locate the displays in suitable positions.

### SUMMARY

The disclosed embodiments have been developed in light of the above and aspects of the invention may include a system of arena-type movable displays. The system may include a support structure which movably supports one or more electronic displays, and means for moving or other driving elements configured to change the position of the displays. The position of the displays may be changed by changing the location and/or orientation of the displays. In one embodiment, the displays are suspended and may be moved along one or more tracks or rails or via one or more cables.

In some embodiments, the rails may comprise at least one longitudinal rail and at least one cross-lateral rail. The longitudinal rail and the cross-lateral rail may be joined at a rail intersection. Mounts may be provided and configured to move from the cross-lateral rail to the longitudinal rail via the rail intersection. The rails may also comprise at least one curved rail that joins with at least one of the longitudinal rail and the cross-lateral rail at a second rail intersection.

The overhead support structure may include first supports disposed at a first vertical position and second supports disposed at a second vertical position. A display supported by the second supports may be movable to a third vertical position located between the first vertical position and the second vertical position.

In another exemplary embodiment, a support structure is provided for movable arena-type displays. The support structure may include first supports with at least one longitudinal support, at least one cross-lateral support, and at least one curved support. Rails may be built into or on the longitudinal, cross-lateral, and curved supports and include rail intersections between the various supports.

First mounts may be provided to move along the rails. The mounts may be configured to hold at least one first arena-type display in order to move the first arena-type display when moved along the rails. Further, second supports may be configured to hold at least one second arena-type display. The second supports may be configured to selectively raise and lower the second arena-type display.

In some embodiments, the first supports are disposed at a first vertical position while the second supports are disposed at a second vertical position that is different from the first vertical position. The second supports may be configured to raise the second arena-type display to a third vertical position between the first vertical position and the second vertical position. In this manner, the first mounts may move the first arena-type display when the second arena-type display is out of the way in the third vertical position.

In some embodiments, first mounts are configured to transfer from one of the longitudinal, cross-lateral, and curved supports to another of the longitudinal, cross-lateral, and curved supports via the rail intersections. The first mounts may further comprise suspension cables, and the first display may be suspended from the suspension cables. The first mounts may also comprise at least one pulley system to change a length of the suspension cables to raise and lower the first display. In one embodiment, a controller is configured to receive control logic instructions to move the first and second displays to one of a plurality of predetermined configurations.

In another exemplary embodiment, a method is provided for changing a configuration of arena-type displays. The method may include providing first supports that include at least one longitudinal support, at least one cross-lateral support, and at least one curved support. Rails are also provided and disposed on the longitudinal, cross-lateral, and curved supports. The rails may include rail intersections between the longitudinal, cross-lateral, and curved supports. The method further comprises providing first mounts disposed on and movable along the rails. The mounts may be configured to hold at least one first arena-type display. Further, the method includes moving the at least one first arena-type display from a first position to a second position by moving the first mounts along the rails, providing second supports configured to hold at least one second arena-type display, and raising and lowering the second arena-type display via the second supports.

In some embodiments, the first mounts comprise suspension cables to suspend the at least one first arena-type display, and at least one pulley system to change the length of the suspension cables. The method may thus also comprise changing a vertical position of the at least one first display by changing the length of the suspension cables via the pulley system. In some embodiments, the at least one first display is moved to change the orientation of the at least one first display.

The first supports may be disposed at a first vertical position, and the second supports may be disposed at a second vertical position different from the first position. The second arena-type display may be raised to a vertical position between the first position and the second position. While the second display is in this position, the first mounts may move along the rails. As one further example of movement, the display may be rotated by moving the mounts along the curved rail.

Further objects, features, and advantages of the present invention over the prior art will become apparent from the detailed description of the drawings which follows, when considered with the attached figures.

### BRIEF DESCRIPTION OF THE DRAWINGS

FIG. 1 shows movable arena-type displays according to an exemplary embodiment.

FIG. 2 shows side views and a top view of the movable arena-type displays according to an exemplary embodiment.

FIG. 3 shows a possible configuration of movable arena-type displays according to an exemplary embodiment.

FIG. 4 shows arena-type displays in a possible tilted configuration according to an exemplary embodiment.

FIG. 5 shown an exemplary arena-type display movement controller, according to one exemplary embodiment.

FIG. 6 shows arena-type displays in another possible tilted configuration according to an exemplary embodiment.

FIG. 7 shows arena-type displays in a first configuration according to one exemplary embodiment.

FIG. 8 shows arena-type displays in a second configuration according to one exemplary embodiment.

FIG. 9 shows arena-type displays in a first transition position to an exemplary stage configuration.

FIG. 10 shows arena-type displays in a second transition position to an exemplary stage configuration.

FIG. 11 shows arena-type display in a third transition position to an exemplary stage configuration.

FIG. 12 show a stage configuration of arena-type displays according to an exemplary embodiment.

### DETAILED DESCRIPTION OF EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention comprise systems and methods for movably mounting electronic video displays, and particularly to systems and methods for movably suspending arena-type displays. In one embodiment, one or more displays are suspended from a support structure. The position of the one or more displays, such as the location and/or orientation of a display, can be changed.

FIG. 1 shows a configuration of movable arena-type displays according to an exemplary embodiment of the invention. One embodiment of a system of the invention comprises a support structure 1 for movably supporting one or more displays, and one or more displays 2, 3, 4. The displays preferably comprise electronic video displays, but may comprise other types of displays. For example, the displays may comprise relatively thin panel LED, LCD, OLED, plasma, DLP or other types of displays now known or later developed. The displays might comprise other types of displays, however, such as rolling media displays or the like.

The support structure 1 is designed to movably support the one or more displays 2, 3, 4. In a preferred embodiment, the support structure 1 is designed to support the displays 2, 3, 4 in a suspended position, e.g. from an overhead position. The support structure 1 may comprise part of a ceiling, roof, walls, or other portions of a structure, or be connected to or supported by such elements, or may be entirely self supported. Preferably, however, the support structure 1 is designed to support the displays 2, 3, 4 in a suspended position. In the case of an arena, the displays 2, 3, 4 are preferably suspended above the floor and seats of the arena. Also, as described below, the support structure 1 supports the displays 2, 3, 4 for movement.

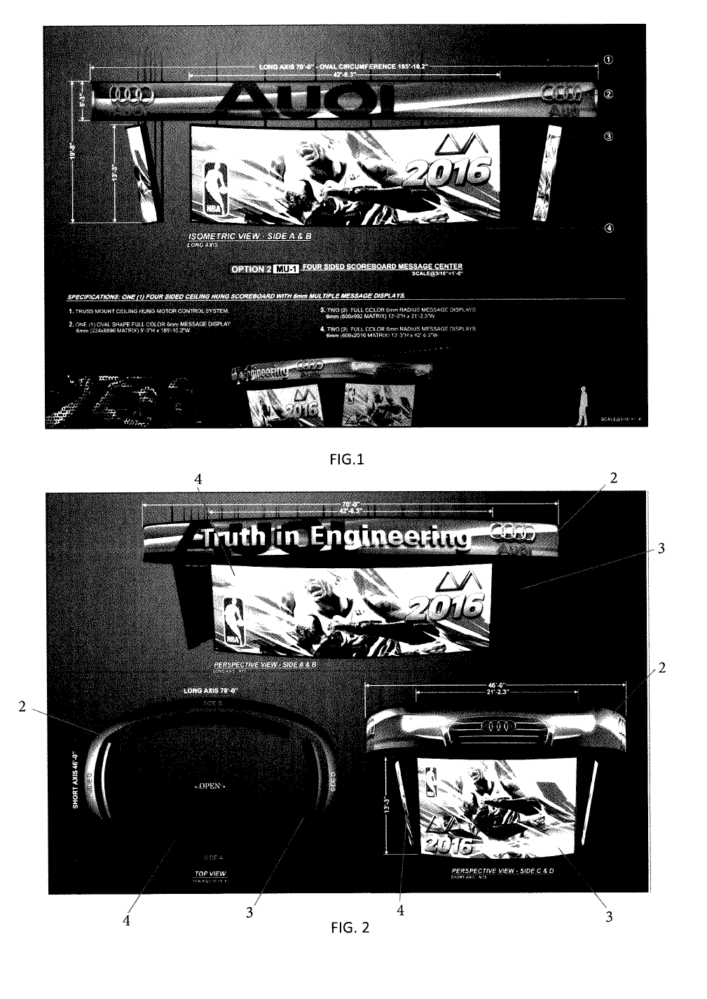

The support structure 1 may comprise, for example, various mounts, rails, struts, trusses, or other elements. The support structure 1 may support one or more displays 2, 3, 4, or other preferable displays of various configurations including different shapes and sizes. For example, as illustrated in FIG. 2, the support structure 1 may support a full oval-shaped message display 2, two shorter arena-type displays 3, and two longer arena-type displays 4.

The support structure 1 supports the displays 2, 3, 4 for movement. In one or more embodiments, the support structure 1 may include one or more rails or tracks which rollably support the displays. For example, the displays 2, 3, 4 may be connected (directly or indirectly, such as via cables) to wheeled mounts which engage tracks. In other embodiments, the support structure 1 may include one or more cables, chains, belts, or other elements which are used to movably support the displays 2, 3, 4. The configuration of the support structure 1 may determine the range of display positions. For example, the support structure 1 might include tracks or rails which extend from one end of an arena to the other, thus permitting one or more displays 2, 3, 4 to be moved entirely along the length of the arena. In other embodiments, the support structure 1 might only be configured to permit certain ones of the displays 2, 3, 4 to be moved to different locations at one end of an arena and others of the displays 2, 3, 4 to be moved to different locations at an opposing end of the arena. In general, the support structure 1 may be configured to suit the desires of the operator.

The one or more rails, tracks or other elements may have various shapes, lengths or the like. For example, when the displays 2, 3, 4 are mounted for movement along one or more rails or tracks, the rails or tracks may be straight and/or curved. Certain rails or tracks may intersect, thus permitting a display to be moved from one rail or track to another. In one embodiment, a display may be mounted for movement along a rail or track and that rail or track may itself be mounted for movement. As described herein, the support structure 1 may include mounts at different levels or vertical positions, such as one set of tracks at a first vertical level for one or more first displays and another set of tracks at a second vertical level for one or more second displays.

The support structure 1 also preferably includes means for moving the displays 2, 3, 4. The means for moving may comprise, but is not limited to, one or more motors, winches, cranes, pistons, or other driving elements. For example, in an embodiment where the displays 2, 3, 4 are mounted on mounts which engage one or more tracks or rails of the support structure 1, one or more drive motors may be used to drive wheels, pull cables, drive a belt or chain or otherwise apply one or more driving forces which cause the display to be moved along the track/rail. In an embodiment where the displays are suspended by cables or the like, winches may be used to spool the cables in and out, thus changing the position of the display(s) 2, 3, 4.

Various exemplary embodiments of the invention will now be described.

FIG. 2 shows side views and a top view of one embodiment of a system of the invention which includes an oval shaped display 2, two short displays 3, and two long displays 5. In this embodiment, the short displays 3 may be configured to be disposed substantially parallel to one another facing in opposite directions, and the longer displays 4 may be disposed substantially parallel to one another facing opposite directions. The shorter displays 3 and longer displays 4 may be disposed substantially perpendicular to each other such that the four displays 3, 4 form an approximately rectangular configuration. Each of the short and long displays 3, 4 may be curved as shown in FIG. 2. Of course, other configurations of displays may be utilized, such as by omitting the oval display 2 and/or including other displays. In this regard, the system of the invention may be implemented relative to a single display or multiple displays of essentially any number.

The full oval-shaped message display 2 may be wider than the short displays 3 and longer than the long displays 4. This may facilitate the movement of the displays, which will be explained in more detail below.

As shown in FIGS. 1-3, each of the displays 2, 3, 4 is configured to be movable independently of the others. Preferably, each display 2, 3, 4 is individually suspended or mounted to the support structure 1 (although it is possible to mount two or more displays so that they move in tandem). This facilitates independent movement of each of the displays 2, 3, 4, as will be explained in more detail below.

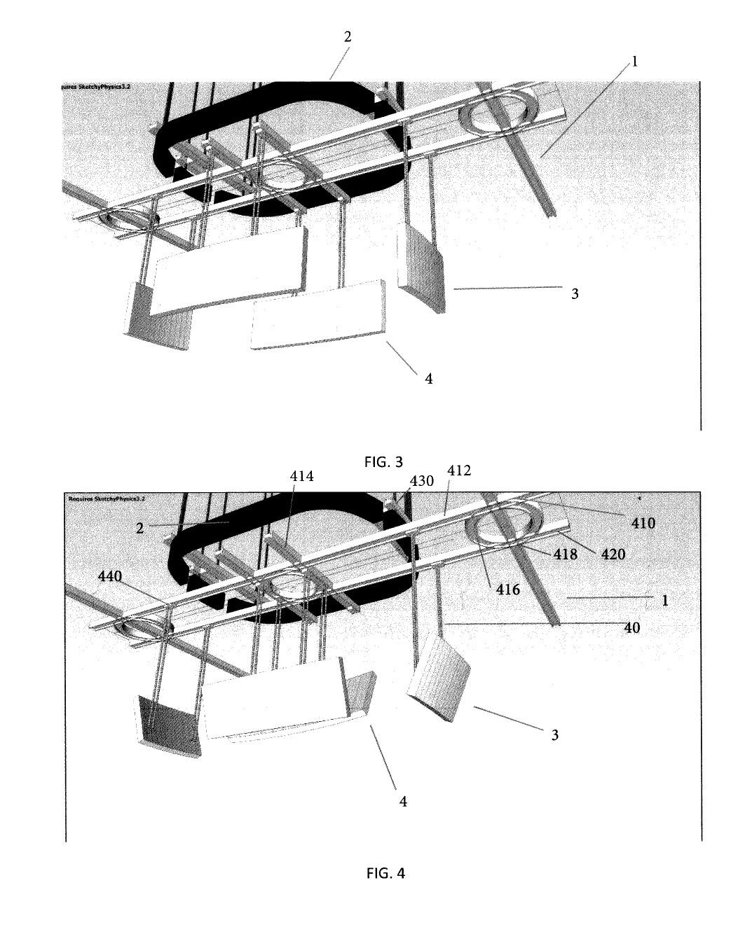

FIG. 3 shows a possible configuration of movable arena-type displays according to an exemplary embodiment. As shown in FIG. 3, the oval-shaped message display 2 may be formed in sections (such as from a plurality of individual displays). The sections may correspond to mounts or supports of the support structure 1. Further, the oval-shaped message display 2, may be suspended from a higher portion of the support structure 1 than the long and short displays 3, 4. This allows the oval-shaped message display 2 to be raised above mounts for the displays 3, 4, as shown in FIG. 3. With the oval-shaped message display 2 in this position, the other displays 3, 4 may be freely movable.

In one embodiment, the displays are mounted for movement in a manner which permits their orientation to be changed. For example, the system may permit the orientation of the displays to be changed by tilting and/or panning the displays. FIG. 4 shows arena-type displays in a possible tilted configuration according to an exemplary embodiment. Each of the displays 3, 4 are configured to be rotatable along a horizontal axis. This allows the displays to be moved from a vertical orientation (in which they extend in a vertical plane) to a tilted orientation (offset from a vertical plane). In one embodiment, the displays may be tilted as much as 45 degrees from the vertical orientation or more.

Tilting of the displays may be achieved by suspending them from the support structure 1 by one or more suspension cables 40. For example, suspension cables 40 may be attached to each display 3, 4 at four positions near the corners of the display 3, 4. In this manner, the orientation of each display 3, 4 may be changed to any desired orientation by adjusting the lengths of the suspension cables 40. In other embodiments, the displays 3, 4 may include a motorized orientation device positioned along the axis of rotation. The orientation device may include an attachment point from which the displays 3, 4 are suspended from the support structure 1. The orientation or tilt of the displays 3, 4 may be controlled by rotating the display via the motorized orientation device. In embodiments where the displays 3, 4 are mounted to mounts, the displays may be movably mounted to the mounts, such as via one or more pivots, hinges or the like. The orientation of the displays may then be changed relative to those mounts.

In an embodiment where suspension cables 40 are utilized, those cables may be connected to the support structure 1. The support structure 1 includes supports 410 that support one or more mounts 440, as described above. The supports 410 may include a set of longitudinal supports 412 that extend in a first direction, a set of cross-lateral supports 414 that extend in a second direction perpendicular to the first direction, and one or more curved supports 416 that may connect to the first and second supports 412, 414 at support intersections 418. Each of the supports 412, 414, 416 may include rails 420 along which the mounts 440 may move. As explained above, the support structure 1 may include second level supports 430 disposed at a different height from the supports 410. The second level supports 430 may include similar features as the supports 410. As shown in FIG. 3, the second level supports 430 may facilitate movement of the displays 3, 4, by raising the display 2 above the supports 410, as will be explained in more detail below. Of course, in other configurations, there may be any number of levels of supports based on the desired configurations and number of displays used.

The mounts 440 may themselves be movable, such as long the rails 420 or the like. The mounts 440 support the suspension cables 40 and may comprise or include sufficient hoists, pulleys, motors, and the like to suspend the displays 3, 4, from the support structure 1 and change the position of the cables to thus change the orientation of the displays and, in one or more embodiments, change the location of the displays 3, 4. In one embodiment, the location of a display may be changed by changing its height (e.g. raising or lowering it). In a preferred embodiment, the location of a display may be changed by moving the display laterally and/or vertically. In a preferred embodiment of the invention, the displays are movable in as many as six degrees of freedom (along an x-axis, y-axis and/or z-axis, and/or about (e.g. rotated about) those axes). Relative to an arena, this permits the location of display to be changed by moving it: up or down, longitudinally from one end of the arena towards the other, laterally from one side of the area towards the other, or by rotating the display, such as to tilt, yaw, and/or pan the display). Of course, each and every display need not be mounted to have the same degree(s) of movement.

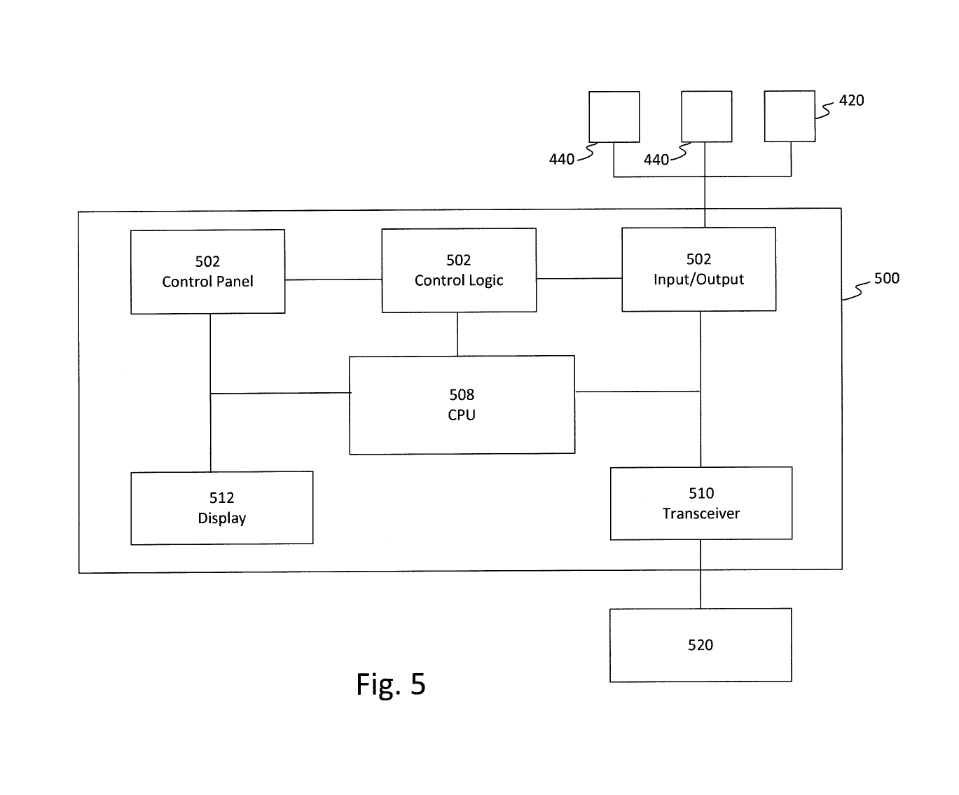

The system preferably includes one or more controllers or a control system, as shown in FIG. 5. The control system 500 may comprise, for example, a control panel or other input device 502 which is configured to receive user input and generate control instructions or signals. The control instructions or signals may be provided to control logic module 504 which may be a memory storing preprogrammed movement procedures for moving the displays 2, 3, 4, manually or to predetermined configurations. The control logic module 504 may be connected to a CPU 508 for processing the instructions and movement procedures and to an input/output device 506 connected to one or more devices utilized to move the displays 2, 3, 4. The devices may include motors, switches, or other elements of the mounts 440, rails 420 or the like used to move the displays 2, 3, 4. The controller 500 may permit programming of particular paths or patterns of movement of the displays, such as to move one or more displays 2, 3, 4 to particular positions or orientations, or may permit manual movement of one or more of the displays. As one example, the controller 500 may permit a user to select a “normal arena mode” which causes the displays 2, 3, 4 to be moved to the center of the arena, such as for use during a basketball game. The controller might select a “concert mode” which causes the displays 2, 3, 4 to be moved to one end of the area, such as to be located adjacent to or behind a stage of a concert.

The controller 500 might comprise, for example, a computing type device which includes a processor 508, input/output unit 506, and at least one memory 504 capable of storing data, code or the like. The controller 500 may execute machine readable code or “software” which generates signals or instructions which may be output to various control devices 440, 420, such as winches, pulleys, motors, etc. The controller 500 might be configured to receive input from a user or a separate external system 520 via a wired or wireless networked connection to receive the control instructions to relay to the various components of the system. The controller may thus comprise a transceiver 510 for sending and receiving information from the external system 520. The controller 500 may further comprise a display 512 to provide feedback information to a user concerning a state of the system.

It will now be appreciated that the system 1 permits the position (e.g. location and/or orientation) of one or more displays to be changed. The range of positions of the displays is limited only by the configuration of the system, including the support structure and associated means for moving.

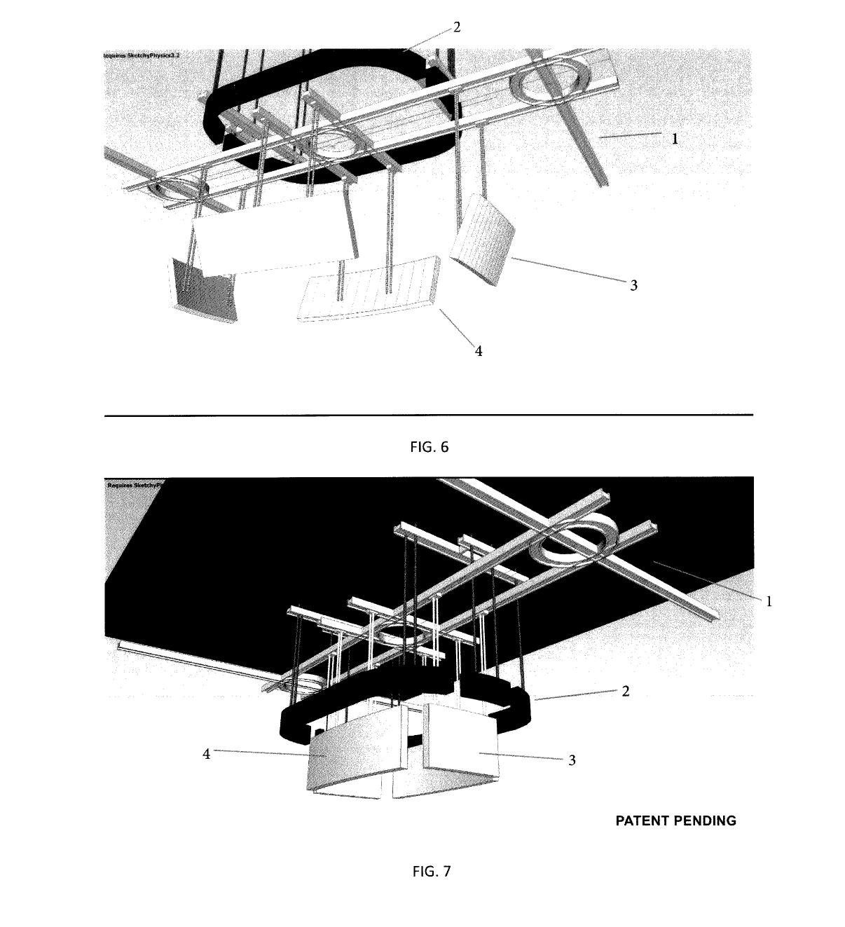

FIG. 6 shows arena-type displays in another possible tilted configuration according to an exemplary embodiment. In the embodiment shown in FIG. 4, the longer displays 4 are brought close together in between the shorter display 3. In the embodiment shown in FIG. 6, the separation between the two longer displays are increased to provide a different viewing configuration for visitors to an arena or similar facility. Numerous other configurations are possible. Some of these will be described in more detail below.

FIGS. 7-12 show arena-type displays transitioning from a first position to a second position according to one exemplary embodiment. These configurations are merely illustrative, as it will be apparent to one of ordinary skill that numerous other configurations may be created using the disclosed system.

In FIG. 7, the displays 2, 3, 4 are in a first position or configuration. In this configuration, the oval-shaped message display 2 is disposed above and around the displays 3, 4. The displays 3, 4 face outward and together to form a substantially rectangular shape—each of the displays 3, 4 being positioned at approximately 90 degrees from adjacent displays 3, 4. Such an arrangement may be suitable for events such as basketball, hockey, or other events taking place in the center of the arena.

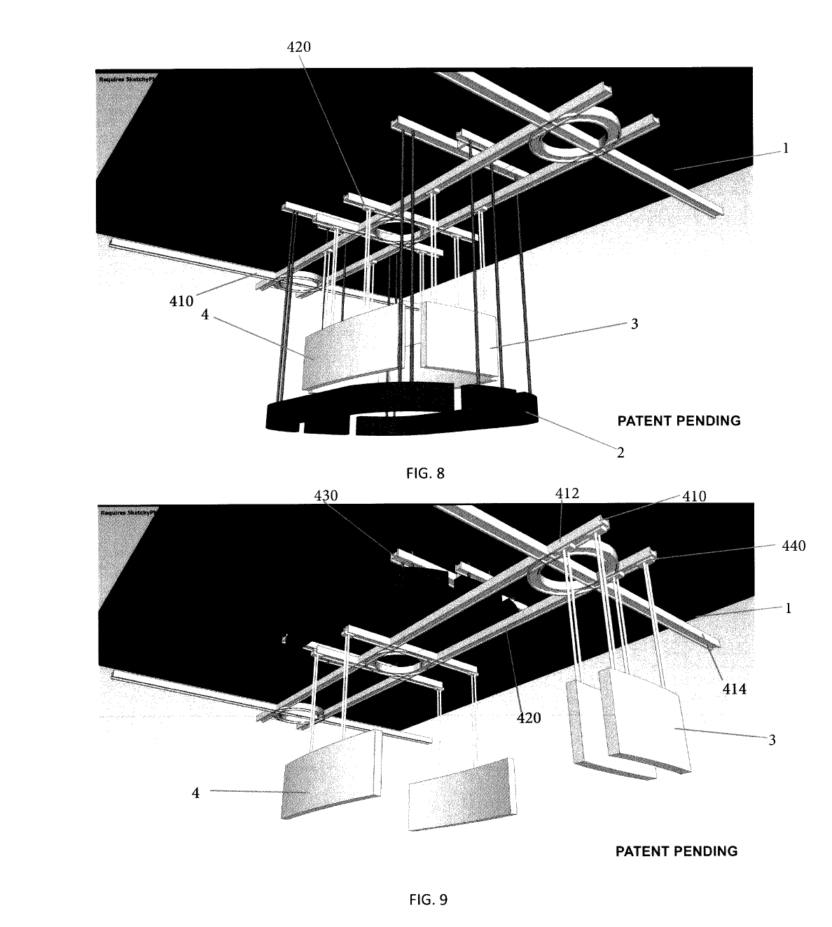

FIG. 8 is another optional first configuration. In FIG. 8, the oval-shaped message display 2 is lowered so as to be below the displays 3, 4. It is further possible to move the longer displays 4 to a position directly above the oval-shaped message display to enhance viewing. As explained previously, the displays 3, 4 may also be tilted depending upon the desired viewing angle.

In FIG. 9, the oval-shaped message display 2 is raised so as to be disposed above at least a portion of the support structure 1. That is, the oval shaped message display 2 is hoisted by the second level supports 430 up above the supports 410. With the oval-shaped message display 2 in this position, the display displays 3, 4 may be moved along the support structure 1. In this example, with the message display 2 above the supports 410, the mounts 440 may move along the rails 420 of the longitudinal and cross-lateral supports 412, 414 to move the displays 3, 4. Here, the longer displays 4 are first moved outwardly along cross-lateral supports 414 to facilitate the movement of the shorter displays 3 to one end of the support structure 1 along the longitudinal supports 412.

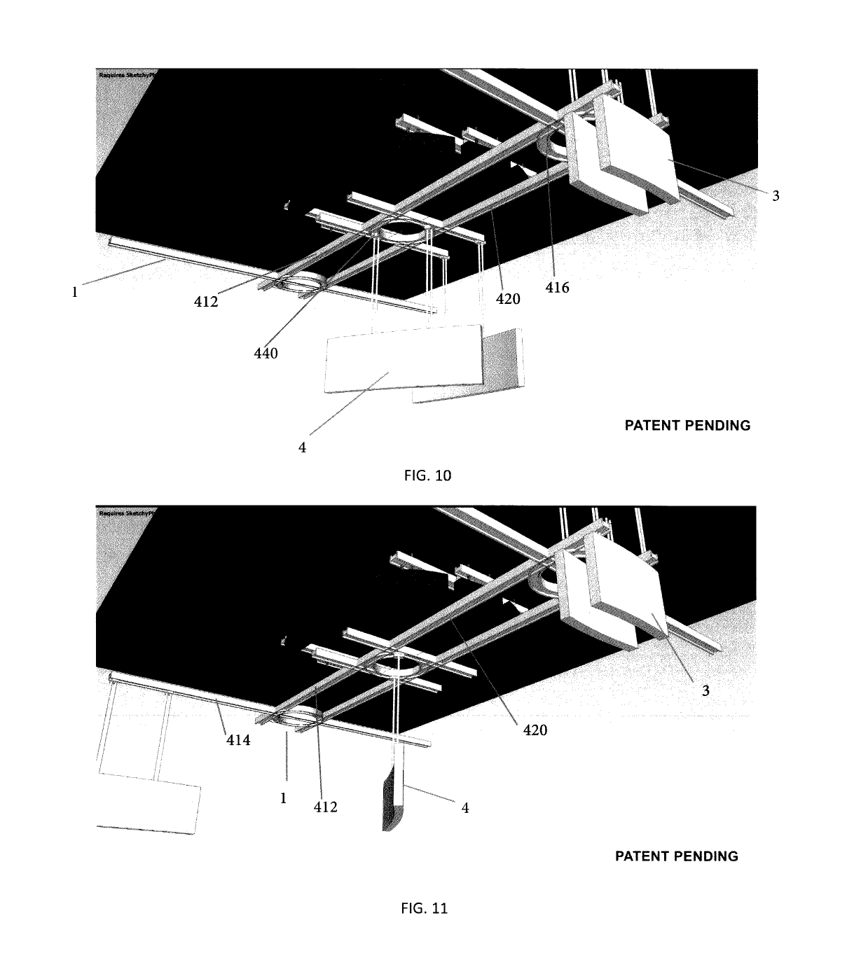

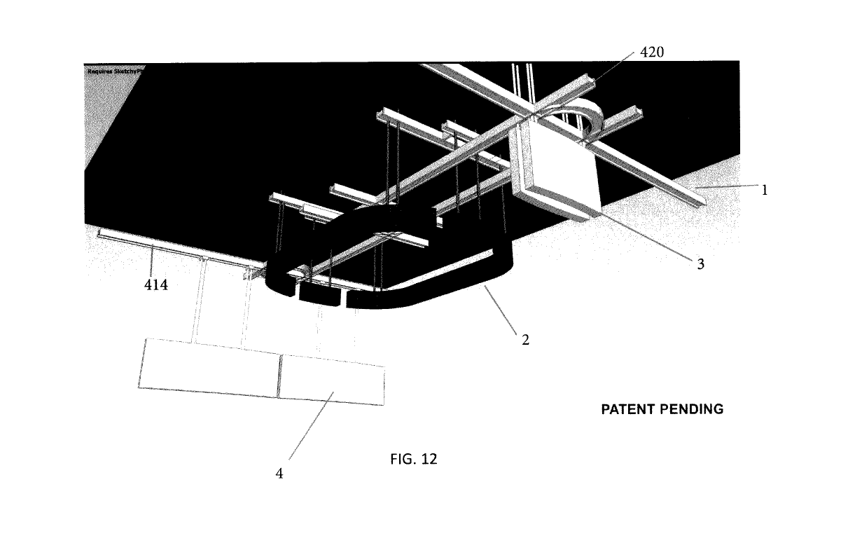

Next, as shown in FIGS. 10, each of the longer displays 4 is rotated about a vertical axis as the mounts 440 run along rails 420 the curved supports 416. Then, in FIG. 11, the longer displays 4 are moved along the longitudinal supports 412 toward the other end of the support structure 1. In FIG. 12, once at the end of the support structure 1, the longer displays 4 may be moved laterally along rails 420 of the cross lateral supports 412. The longer displays 4 are placed next to one another and the oval-shaped message display 2 is again lowered to be in a predetermined viewing position. Thus, the displays 2, 3, 4 are brought into a second position or configuration. This configuration may be suitable for events that take place on a stage at one side of the arena or other facility, such as a concert, a show, a speech, or the like.

Thus, as explained above, the disclosed embodiments allow for displays that can be moved into any desired configuration. This allows an events center such as an arena to be extremely versatile. The displays can be modified to configure the venue in a variety of ways which allow the venue to be used as a truly multi-purpose venue. This allows owners of such venues to successfully host a wide variety of events, thus raising potential revenue obtained from such a venue. These advantages are realized by utilizing a limited number of displays and by changing the position of those displays, rather than by adding displays and/or mounting a plurality of different displays in fixed positions throughout the arena or other structure.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A system of arena-type movable displays comprising:
an overhead support structure configured to movably support at least one electronic video display;
mounts suspending said at least one electronic video display from said overhead support structure; and
rails along which said mounts move to change a position of said at least one electronic video display relative to said support structure.

2. The system in accordance with claim 1 wherein said mounts are configured to change an orientation of said at least one electronic video display.

3. The system in accordance with claim 1 wherein said mounts are configured to change a location of said at least one electronic video display.

4. The system in accordance with claim 1 wherein said mounts comprises at least one cable and at least one of a wench and pulley device configured to change a length of said cable relative to said at least one electronic video display.

5. The system in accordance with claim 1 wherein said rails comprise at least one longitudinal rail and at least one cross-lateral rail, the longitudinal rail and the cross-lateral rail being joined at a rail intersection, and the mounts being configured to move from the cross-lateral rail to the longitudinal rail via the rail intersection.

6. The system in accordance with claim 5, wherein said rails further comprise at least one curved rail, the at least one curved rail being joined at a second rail intersection with at least one of the longitudinal rail and the cross-lateral rail.

7. The system in accordance with claim 1, wherein the overhead support structure comprises first supports disposed at a first vertical position and second supports disposed at a second vertical position, the second vertical position being different from the first vertical position.

8. The system in accordance with claim 7, wherein a display supported by the second supports is movable to a third vertical position located between the first vertical position and the second vertical position.

9. A support structure for movable arena-type displays comprising:
first supports that include at least one longitudinal support, at least one cross-lateral support, and at least one curved support;
rails disposed on the longitudinal, cross-lateral, and curved supports, the rails comprising rail intersections between the longitudinal, cross-lateral, and curved supports;
first mounts disposed on and movable along the rails, the mounts being configured to hold at least one first arena-type display, and to move the first arena-type display when moved along the rails; and
second supports configured to hold at least one second arena-type display, the second supports being configured to selectively raise and lower the second arena-type display.

10. The support structure of claim 9, wherein the first supports are disposed at a first vertical position, and the second supports are disposed at a second vertical position that is separate from the first vertical position.

11. The support structure of claim 10, wherein the second supports are configured to raise the second arena-type display to a third vertical position between the first vertical position and the second vertical position, and wherein the first mounts move the first arena-type display when the second arena-type display is in the third vertical position.

12. The support structure of claim 9, wherein the first mounts are configured to transfer from one of the longitudinal, cross-lateral, and curved supports to another of the longitudinal, cross-lateral, and curved supports via the rail intersections.

13. The support structure of claim 9, wherein the first mounts comprise suspension cables, and the first display is suspended from the suspension cables.

14. The support structure of claim 13, wherein the first mounts comprise at least one pulley system to change a length of the suspension cables to raise and lower the first display.

15. The support structure of claim 9, further comprising a controller configured to receive control logic instructions to move the first and second displays to one of a plurality of predetermined configurations.

16. A method of changing a configuration of arena-type displays, the method comprising:
providing first supports that include at least one longitudinal support, at least one cross-lateral support, and at least one curved support;
providing rails disposed on the longitudinal, cross-lateral, and curved supports, the rails comprising rail intersections between the longitudinal, cross-lateral, and curved supports;
providing first mounts disposed on and movable along the rails, the mounts being configured to hold at least one first arena-type display,
moving the at least one first arena-type display from a first position to a second position by moving the first mounts along the rails;
providing second supports configured to hold at least one second arena-type display; and
raising and lowering the second arena-type display via the second supports.

17. The method of claim 16, wherein the first mounts comprise suspension cables to suspend the at least one first arena-type display, and at least one pulley system to change the length of the suspension cables, and wherein the method further comprises changing a vertical position of the at least one first display by changing the length of the suspension cables via the pulley system.

18. The method of claim 17, wherein the method further comprises moving the at least one first display to change the orientation of the at least one first display.

19. The method of claim 16, wherein the first supports are disposed at a first vertical position, the second supports are disposed at a second vertical position different from the first position, and wherein the method further comprises raising the second arena-type display to a vertical position between the first position and the second position, and moving the first mounts along the rails while the second arena-type display is at the third position.

20. The method of claim 16, further comprising rotating the at least on first display about a vertical axis by moving the mounts along the curved rail.
